(19) United States
(12) Patent Application Publication
(10) Pub. No.: US 2013/0000832 A1
(43) Pub. Date: Jan. 3, 2013

(54) Apparatus and Method of Decorating a Gourd

(75) Inventor: Christopher Rodriguez, Greeneville, TN (US)

(73) Assignee: Madison International, LLC., Greeneville, TN (US)

(21) Appl. No.: 13/175,316

(22) Filed: Jul. 1, 2011

(51) Int. Cl. B32B 37/02; B32B 37/12; B32B 38/14; B32B 37/14; B32B 38/04; B32B 3/00; B05D 5/10

(52) U.S. Cl. 156/249; 428/195.1; 156/250; 427/207.1

(57) ABSTRACT

A gourd carving template includes a coded image printed upon waterslide decal paper. The coded image provides indicia for informing the user as to where to remove portions of the gourd. The printed image is then covered with an adhesive layer and the adhesive layer is covered with a removable adhesive paper. Once the adhesive paper is removed the adhesive layer is exposed and can be placed upon the gourd to provide a fully adhesive template for selectively removing portions of the gourd.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

The present invention relates generally to an apparatus and method of decorating a gourd, and more specifically to an apparatus and method of transferring an image to a gourd and selectively removing portions of the gourd according to indicia contained within the transferred image.

2. Description of the Related Art

Many people choose to decorate their homes through the use of ornamented or carved vegetables, in particular gourds. As an example, in anticipation of the American holiday of Halloween, it is traditional that portions of a gourd be removed to create a festive or themed design within the surface of the gourd.

Existing methods of removing portions of a gourd for decorative purposes do include the use of templates. One such template requires the user to draw the intended design upon the gourd with some writing implement or by etching the outline of the design in the surface of the gourd. Because of the non-planar and irregular surfaces that characterize all gourds, this method may be difficult to execute for those that want to create an intricate or complicated design within a gourd. Additionally, individuals that are inexperienced with drawing such designs may have difficulties in executing such complex or intricate designs.

Another template that is used to create a design in a gourd is one that is pre-printed on paper and attached to the gourd through the use of tacks, tape or some other similar fastener. This paper template, after it is placed upon the gourd, provides a guide from which the user can insert a tool through the paper template and into the gourd to demarcate the areas from which portions of the gourd are to be removed. One drawback of this method is that as the user marks the gourd by inserting a tool through the paper template and into the gourd, liquid from the gourd is released thereby saturating the paper template and the fasteners. Once saturated, the paper template becomes difficult to handle and can tear easily.

Also, as the gourd is demarcated and liquid from the gourd is released, the fasteners, especially adhesive fasteners, may become loosened and detach from the gourd, thereby requiring the repositioning of the template and the fasteners. Additionally, because a paper template requires the user to place on object through it in order to mark the gourd, the paper template is continually and increasingly destroyed during use thereby making it increasingly difficult to keep the paper template in place and use the paper template to complete the design as originally intended.

### BRIEF SUMMARY OF THE INVENTION

A gourd carving template includes a coded image printed upon waterslide decal paper. The coded image provides indicia for informing the user as to the removal of selected portions of the gourd. The printed image is covered with an adhesive layer that is attached to a removable adhesive paper. Once the adhesive paper is removed, the exposed adhesive layer can be placed upon the gourd to provide an adhesive template to selectively remove portions of the gourd.

Embodiments of the current invention also describe methods of selectively removing portions of a gourd using the gourd carving template to create an adhesive template that adheres to the surface of a gourd such that specific portions of the gourd can be removed to create a desired design.

### BRIEF DESCRIPTION OF THE SEVERAL VIEWS OF THE DRAWINGS

The drawings that depict the various views and embodiments are as follows:

FIG. 1 is a plan view of the gourd carving template with a coded image included therein;

FIG. 2 is a section view, as indicated in FIG. 1, of the layers comprising the gourd carving template;

FIG. 3 is a partial exploded axonometric of the gourd carving template;

FIG. 4 is a flowchart that describes the operations involved in using the gourd carving template to result in the desired image being created upon and within the surface of the gourd;

FIG. 5 is an illustration showing a particular operation in the method of utilizing the gourd carving template;

FIG. 6 is a section view, taken as indicated in FIG. 5, showing a particular operation in the method of using the gourd carving template;

FIG. 7 is an illustration showing a particular operation in the method of utilizing the gourd carving template;

FIG. 8 is an illustration showing a particular operation in the method of utilizing the gourd carving template;

FIG. 9 is an illustration showing a particular operation in the method of utilizing the gourd carving template; and

FIG. 10 is an illustration showing a particular operation in the method of utilizing the gourd carving template.

### DETAILED DESCRIPTION OF THE INVENTION

A gourd carving template 10 is described herein and illustrated by the accompanying figures. The gourd carving template 10 can be used with a gourd to provide the user with indicia for selectively removing portions of the gourd. For example the gourd carving template can be used indoors or outdoors.

While the title of the disclosed apparatus, gourd carving template, implies that the disclosed apparatus and method are limited to use on gourds, this title is not intended to and does not limit the use of the apparatus and method only as to gourds. One skilled in the art would appreciate that this method and apparatus can also be used to carve other produce items, or articles of produce, with outer surfaces that can be selectively removed with a standard cutting blade or other cutting tools.

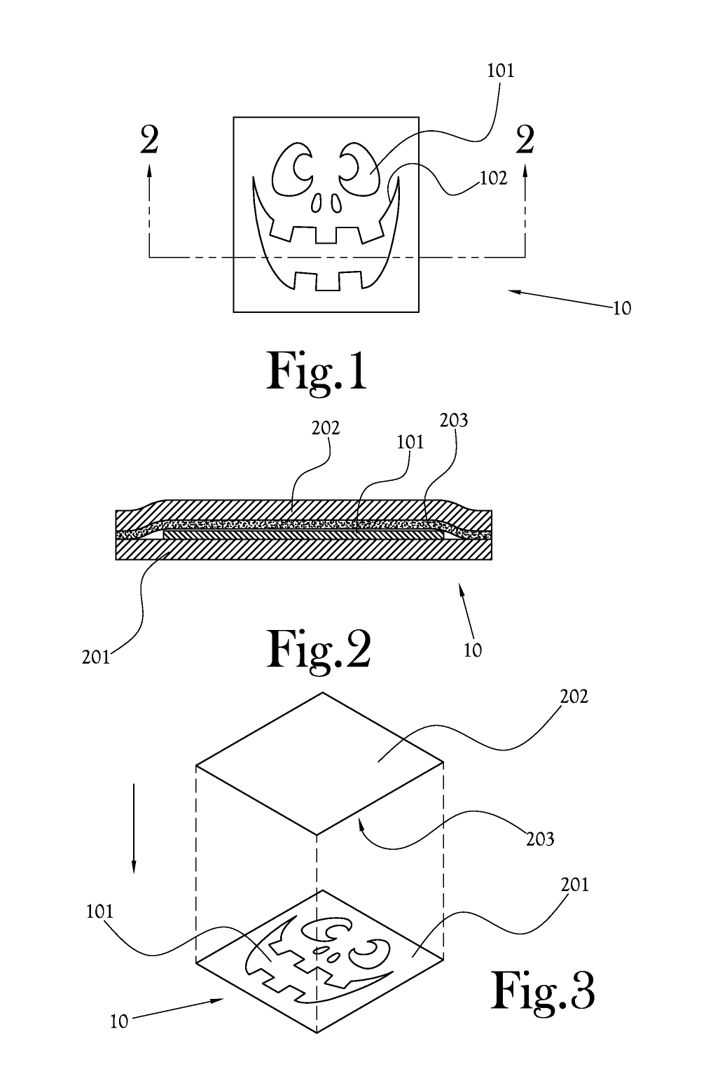

FIG. 1 shows a plan view of one embodiment of the gourd carving template 10 with the coded image 101 included thereon. The coded image 101 can be a graphic image printed on a waterslide decal paper 201.

The indicia 102 serves to inform the user as to which selected portions of the gourd are to be removed in order to result in the desired image being created by the remaining portions of the gourd. In an alternate embodiment, the coded image can contain multiple indicia 102 that provide information as to various techniques for removing specific portions of the gourd and what locations such techniques can be used to arrive at the intended design for the gourd. Such techniques may include, among others, cutting through the surface of the gourd, scraping away portions of the skin of the gourd, or etching portions of the gourd. The multiple indicia 102 may take the form of distinguishing colors, hatch patterns, line types, or any other type of marking to indicate portions of the gourd to be designated for removal.

FIG. 2 shows a section view taken as indicated in FIG. 1. The section view shows the layers that comprise the gourd carving template 10. The waterslide decal paper 201 can be of a kind and type substantially similar to that manufactured by Bel, Inc., and suitable for use in laserjet printers, inkjet printers or copiers. The coded image 101 can be printed upon the waterslide decal paper 201 through the use of a printer or copier. The adhesive paper 202 can be of a kind and type substantially similar to that manufactured by Bel Inc. and contains an adhesive layer 203.

FIG. 3 illustrates the waterslide decal paper 201 that has received the coded image 101. The adhesive paper 202 includes an adhesive layer 203 that is placed upon the side of the waterslide decal paper 201 that has received the coded image 101. The coded image 101 is thereby encased between the waterslide decal paper 201 and the adhesive layer 203, as illustrated in FIG. 2.

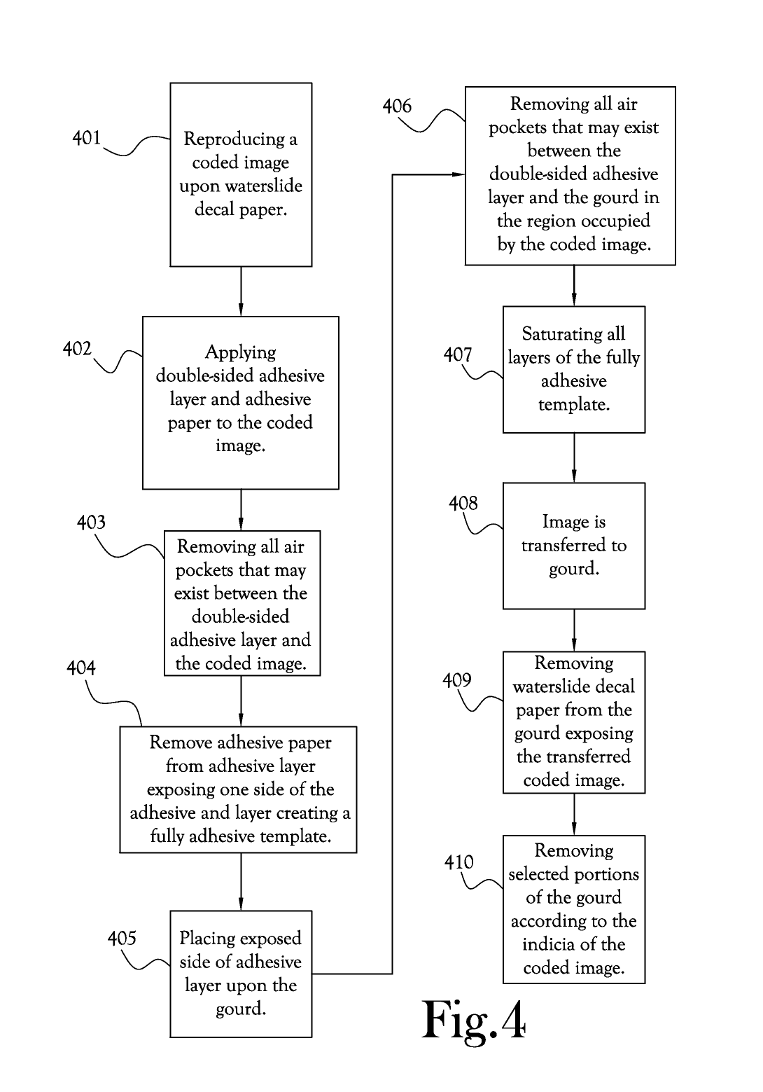

FIG. 4 illustrates a flow chart setting forth exemplary operations in a method that the user can utilize with the gourd carving template described and illustrated in FIGS. 1 through 4. This method is more fully described in this flow chart and illustrated in the Figures.

Referring to operation 401, the coded image 101 can be disposed upon the waterslide decal paper 201 through the use of an inkjet or laserjet printer. In using virtually any type of printer, it is possible to utilize various forms of graphic design software to create the coded image 101.

Referring to operation 402 and again to FIG. 3, the coded image 101 being disposed upon the waterslide decal paper, the user can dispose an adhesive layer 203 upon the coded image 101 and at least those portions of the waterslide decal paper 201 that are occupied by the coded image 101. The adhesive layer 203 can be a two-sided layer with adhesive on both sides.

In the example embodiment, the adhesive layer 203 is disposed upon the coded image 101 and the waterslide decal paper 201 through the use of an adhesive sheet 202. The adhesive sheet 202 can be of a type substantially similar to that manufactured by Bel, Inc. and contains both the adhesive layer 203 and a removable adhesive paper that is removable from the adhesive layer.

Referring to operation 403, once the adhesive layer 203 is disposed upon the coded image 101 and the waterslide decal paper, the user can remove substantially all of the air pockets that may exist between the coded image 101 and the adhesive layer 203. Air bubbles that remain in this region may affect the transfer of the coded image 101 from the waterslide decal paper 201 onto the desired surface.

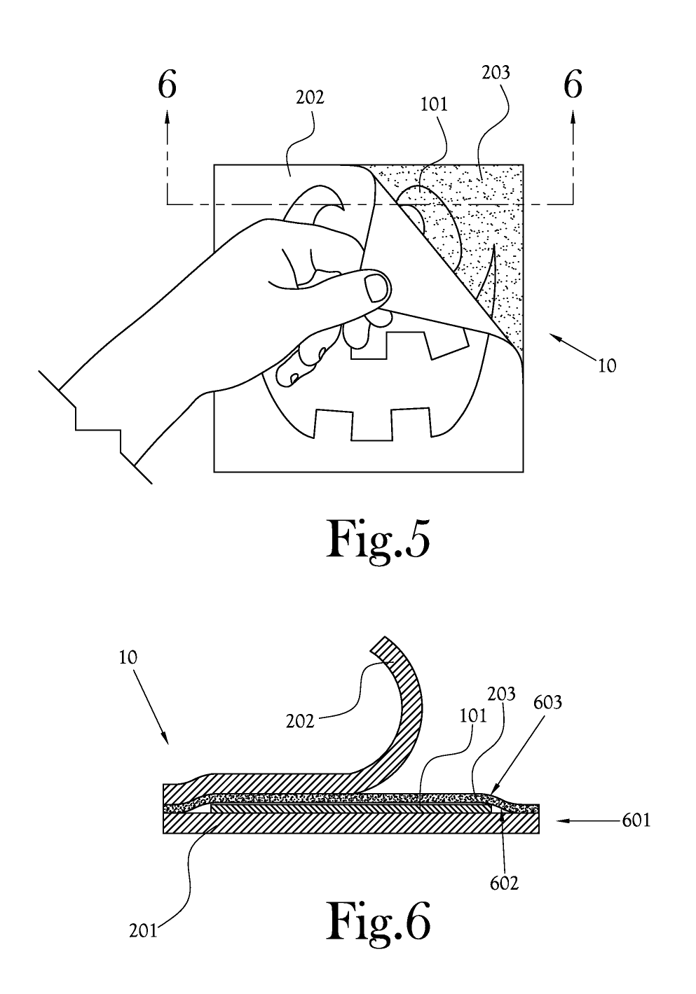

Referring to operation 404 and FIGS. 5 and 6, in the illustrated embodiment, after the adhesive layer 203 is disposed upon the coded image 101 and the waterslide decal paper 201, the user can remove the adhesive paper 202 from the adhesive layer 203 to expose the adhesive layer 203 and creating an adhesive template 601 made up of the waterslide decal paper 201, the coded image 101 and the adhesive layer 203. The first side 602 of the adhesive layer 203 is disposed against the coded image 101 and the waterslide decal paper 201 as indicated in FIG. 6. The adhesive paper being removed, the second side 603 of the adhesive layer 203 is exposed and the second side 603 of the adhesive layer 203 serves as the adhesive for the adhesive template 601 for attaching the coded image 101 and the waterslide decal paper to the gourd 701.

Referring to operation 405, the user disposes the adhesive template upon the desired surface by placing the second side 603 of the adhesive layer 203 upon the desired location of the gourd 701.

Referring to operation 406, in the illustrated embodiment, the user removes substantially all of the air pockets that exist between the desired surface and the second side 603 of the adhesive layer 203. It is possible that having too many air pockets in this region may affect the transfer of the coded image 101 from the waterslide decal paper 201 to the gourd 701.

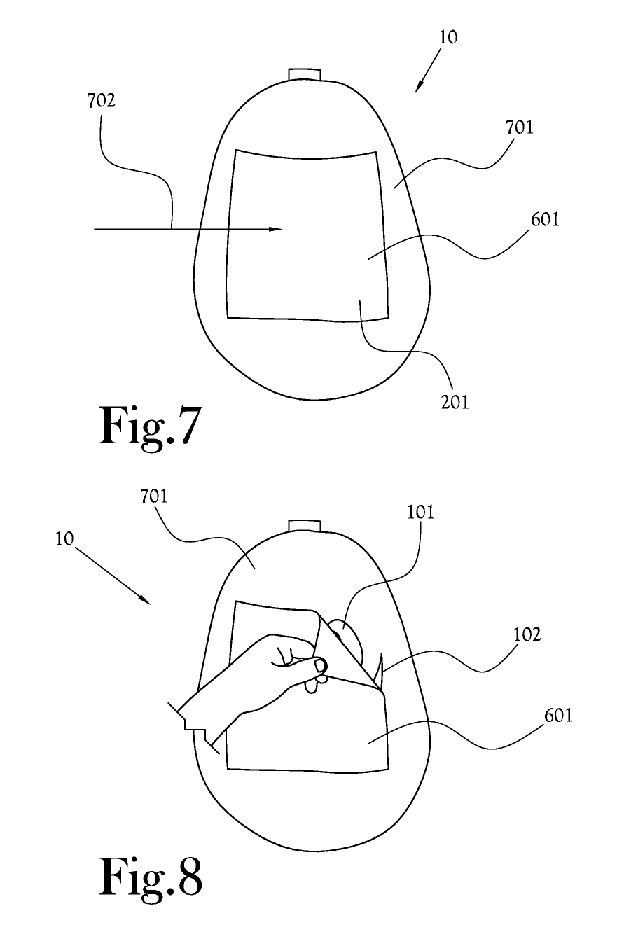

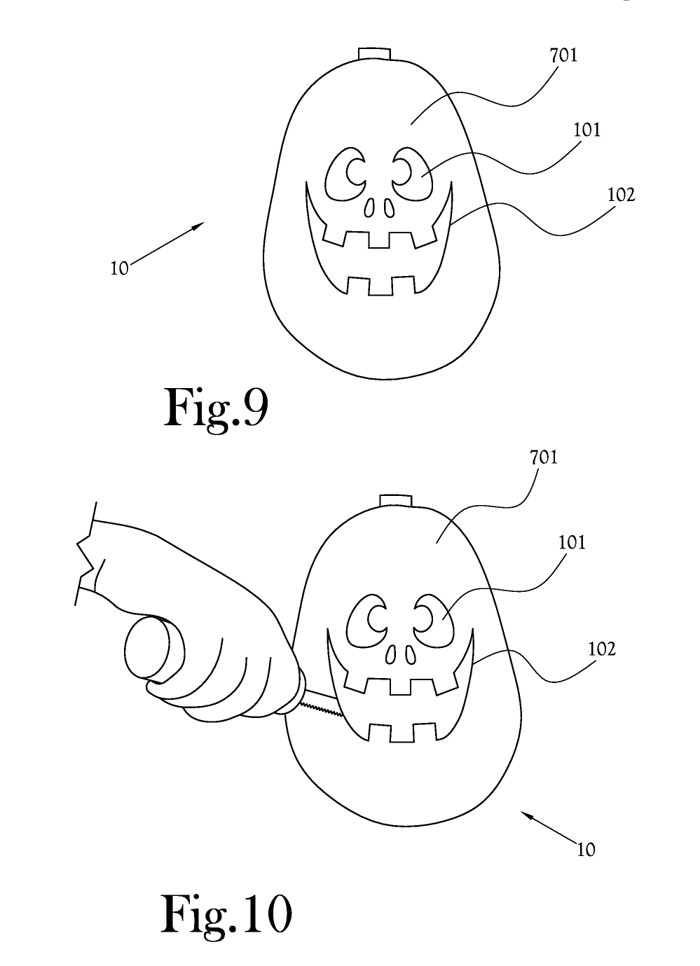

Referring to operation 407 and FIGS. 7, 8 and 9, the user can use a liquid 702 to saturate the adhesive template 601. The liquid can be a substance substantially similar to water. The level of saturation should be any level sufficient to transfer the coded image 101 to the gourd 701 as illustrated in operation 408 and FIGS. 8 and 9.

Referring to operation 409 and FIG. 8, after saturating the fully adhesive layer 601 with the liquid 702 to transfer the coded image 101 to the gourd 701, in the illustrated embodiment, the user can remove the waterslide decal paper 201 from the gourd 701 to reveal the coded image 101 upon the face of the gourd 701.

In an alternate embodiment the waterslide decal paper 201, upon being saturated, can become substantially transparent such that the coded image 101 is visible through the waterslide decal paper 201 such that the user can selectively remove portions of the gourd 701 according to the indicia 102 of the coded image 101 without first removing the waterslide decal paper 201.

Referring to operation 410 and FIG. 10, after the coded image 101 is transferred to the gourd 701 and the coded image 101 is visible, the user can selectively remove portions of the gourd 701 according to the indicia 102 contained within the coded image 101.

While the present invention has been illustrated by description of several embodiments and described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A template to transfer a coded image to an article of produce, comprising:
a waterslide decal paper having a coded image printed thereon, the coded image including at least one indicia to identify regions of an article of produce to be removed; and
an adhesive layer disposed upon said coded image to attach said coded image and said waterslide decal paper to said article such that said coded image is located between said waterslide decal paper and said adhesive layer to transfer said coded image to the regions of said article to be removed.

2. The template of claim 1 wherein said at least one indicia include separate colors.

3. The template of claim 1 wherein said at least one indicia include separate hatch patterns.

4. The template of claim 1 wherein said at least one indicia include separate line patterns.

5. The template of claim 1 wherein said adhesive layer comprises first and second sides, said first side being disposed upon said coded image and said second side includes a removable adhesive paper such that when said adhesive paper is removed, said second side is exposed to attach said coded image and said waterslide decal paper to said article.

6. The template of claim 5 wherein said at least one indicia include separate colors.

7. The template of claim 5 wherein said at least one indicia include separate hatch patterns.

8. The template of claim 5 wherein said at least one indicia include separate line patterns.

9. A method of selectively removing portions of an article of produce, comprising:
reproducing a coded image onto a sheet of waterslide decal paper, said coded image including at least one indicia to identify regions of an article of produce to be selectively removed;
disposing an adhesive layer upon said coded image such that said coded image is located between said waterslide decal paper and said adhesive layer;
adhering said adhesive layer upon said article to attach said coded image and said waterslide decal paper to said article;
transferring said coded image to said regions of said article to be selectively removed; and
removing said regions of said article according to said indicia of said coded image transferred to said article.

10. The method of claim 9, wherein said adhesive layer comprises first and second sides, said first side being disposed upon said coded image, said second side including a removable adhesive paper covering said second side such that when said adhesive paper is removed, said second side is exposed to attach said coded image and said waterslide decal paper to said article.

11. The method of claim 10 wherein said adhesive layer is disposed upon said waterslide decal paper and said coded image through the use of a removable adhesive sheet disposed against said second side of said adhesive layer.

12. The method of claim 11 wherein transferring said coded image comprises substantially saturating said waterslide decal paper and said adhesive layer with sufficient liquid to transfer said coded image to said article.

13. The method of claim 12 wherein substantially all pockets of air are removed from between said first side of said adhesive layer and said coded image.

14. The method of claim 13 wherein substantially all pockets of air are removed from the region occupied by said coded image and that lie between said second side of said adhesive layer and said article.

15. The method of claim 14 wherein said waterslide decal paper and said adhesive layer are sufficiently saturated to transfer said coded image from said waterslide decal paper to said article.

16. The method of claim 15 wherein the saturated waterslide decal paper is removed from said article.

17. The method of claim 16 wherein the user selectively removes portions of said article according to said indicia contained within said coded image.

18. The method of claim 17 wherein said coded image is disposed upon said waterslide decal paper through the use of an inkjet printer, laserjet printer, or copier.

19. The method of claim 18 wherein said coded image is created using graphic design software and transferred to said inkjet printer or said laserjet printer via electronic means.

20. A method of making a template to transfer a coded image to an article of produce, the method comprising:
reproducing a coded image onto a sheet of waterslide decal paper, said coded image including at least one indicia to identify regions of an article of produce to be selectively removed; and
disposing an adhesive layer to said coded image to adhere said coded image and said waterslide decal paper to said article such that said coded image is located between said waterslide decal paper and said adhesive layer to transfer said coded image to the region of said article to be removed.
